(19) United States
(12) Patent Application Publication
(10) Pub. No.: US 2025/0039834 A1
(43) Pub. Date: Jan. 30, 2025

(54) COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN); Xinlei YU, Dongguan (CN)

(73) Assignee: GUANGDONG OPPO MOBILE TELECOMMUNICATIONS CORP., LTD., Dongguan (CN)

(21) Appl. No.: 18/914,592

(22) Filed: Oct. 14, 2024

Related U.S. Application Data
(63) Continuation of application No. PCT/CN2022/102216, filed on Jun. 29, 2022.

(51) Int. Cl. H04W 64/00; H04W 72/1268; H04W 74/0833; H04W 76/20; H04W 84/06

(52) U.S. Cl. CPC H04W 64/00; H04W 72/1268; H04W 74/0833; H04W 76/20; H04W 84/06

(57) ABSTRACT

A communication method and a communications apparatus are provided. The method includes: performing, by a terminal device, global navigation satellite system GNSS measurement to obtain a GNSS location of the terminal device, where the terminal device is in a connected state; and transmitting, by the terminal device, first information to a network device, where the first information is used to indicate that the GNSS location is valid.

### CROSS-REFERENCE TO RELATED APPLICATIONS

This application is a continuation of International Application No. PCT/CN2022/102216, filed on Jun. 29, 2022, the disclosure of which is hereby incorporated by reference in its entirety.

### TECHNICAL FIELD

This application relates to the field of communications technologies, and more specifically, to a communication method and a communications apparatus.

### BACKGROUND

In a non-terrestrial network (NTN) system, a terminal device in a connected state may perform GNSS measurement by using a global navigation satellite system (GNSS) module. However, a GNSS module and a communications module of a terminal device cannot operate simultaneously. When performing GNSS measurement, the terminal device needs to disable the communications module, which may affect scheduling of a network device.

### SUMMARY

Embodiments of this application provide a communication method and a communications apparatus. Various aspects involved in embodiments of this application are described below.

According to a first aspect, a communication method is provided. The method includes: performing, by a terminal device, global navigation satellite system GNSS measurement to obtain a GNSS location of the terminal device, where the terminal device is in a connected state; and transmitting, by the terminal device, first information to a network device, where the first information is used to indicate that the GNSS location is valid.

According to a second aspect, a communication method is provided. The method includes: receiving, by a network device, first information transmitted by a terminal device, where the first information is used to indicate that a global navigation satellite system GNSS location of the terminal device is valid, and the GNSS location is obtained by performing GNSS measurement when the terminal device is in a connected state.

According to a third aspect, a communication method is provided, where a terminal device maintains a timer, the timer is used to determine remaining validity time of a global navigation satellite system GNSS location of the terminal device, and the method includes: restarting, by the terminal device, the timer in a case that third information transmitted by a network device is received, where the third information is used for the terminal device to perform time domain resource compensation and/or frequency domain resource compensation.

According to a fourth aspect, a communication method is provided. The method includes: transmitting, by a network device, third information to a terminal device, such that the terminal device restarts a timer in a case that the third information is received, where the timer is deployed on the terminal device, the timer is used to determine remaining validity time of a global navigation satellite system GNSS location of the terminal device, and the third information is used for the terminal device to perform time domain resource compensation and/or frequency domain resource compensation.

According to a fifth aspect, a communications apparatus is provided. The apparatus includes: a measurement unit, configured to perform global navigation satellite system GNSS measurement to obtain a GNSS location of the apparatus, where the apparatus is in a connected state; and a transmitting unit, configured to transmit first information to a network device, where the first information is used to indicate that the GNSS location is valid.

According to a sixth aspect, a communications apparatus is provided. The apparatus includes: a receiving unit, configured to receive first information transmitted by a terminal device, where the first information is used to indicate that a global navigation satellite system GNSS location of the terminal device is valid, and the GNSS location is obtained by performing GNSS measurement when the terminal device is in a connected state.

According to a seventh aspect, a communications apparatus is provided, where the apparatus maintains a timer, the timer is used to determine remaining validity time of a global navigation satellite system GNSS location of the apparatus, and the apparatus includes: a restarting unit, configured to restart the timer in a case that third information transmitted by a network device is received, where the third information is used for the apparatus to perform time domain resource compensation and/or frequency domain resource compensation.

According to an eighth aspect, a communications apparatus is provided. The apparatus includes: a transmitting unit, configured to transmit third information to a terminal device, such that the terminal device restarts a timer in a case that the third information is received, where the timer is deployed on the terminal device, the timer is used to determine remaining validity time of a global navigation satellite system GNSS location of the terminal device, and the third information is used for the terminal device to perform time domain resource compensation and/or frequency domain resource compensation.

According to a ninth aspect, a communications apparatus is provided. The apparatus includes a memory, a transceiver, and a processor, where the memory is configured to store a program, the processor transmits data and receives data through the transceiver, and the processor is configured to invoke the program in the memory to cause the communications apparatus to execute the method according to the first aspect or the third aspect.

According to a tenth aspect, a communications apparatus is provided. The apparatus includes a memory, a transceiver, and a processor, where the memory is configured to store a program, the processor transmits data and receives data through the transceiver, and the processor is configured to invoke the program in the memory to cause the communications apparatus to execute the method according to the second aspect or the fourth aspect.

According to an eleventh aspect, a communications apparatus is provided. The apparatus includes a processor, configured to invoke a program from a memory to cause the communications apparatus to execute the method according to the first aspect or the third aspect.

According to a twelfth aspect, a communications apparatus is provided. The apparatus includes a processor, configured to invoke a program from a memory to cause the communications apparatus to execute the method according to the second aspect or the fourth aspect.

According to a thirteenth aspect, a chip is provided. The chip includes a processor, configured to invoke a program from a memory to cause a device on which the chip is installed to execute the method according to the first aspect or the third aspect.

According to a fourteenth aspect, a chip is provided. The chip includes a processor, configured to invoke a program from a memory to cause a device on which the chip is installed to execute the method according to the second aspect or the fourth aspect.

According to a fifteenth aspect, a computer-readable storage medium is provided, where a program is stored on the computer-readable storage medium, and the program causes a computer to execute the method according to the first aspect or the third aspect.

According to a sixteenth aspect, a computer-readable storage medium is provided, where a program is stored on the computer-readable storage medium, and the program causes a computer to execute the method according to the second aspect or the fourth aspect.

According to a seventeenth aspect, a computer program product is provided, including a program, where the program causes a computer to execute the method according to the first aspect or the third aspect.

According to an eighteenth aspect, a computer program product is provided, including a program, where the program causes a computer to execute the method according to the second aspect or the fourth aspect.

According to a nineteenth aspect, a computer program is provided, where the computer program causes a computer to execute the method according to the first aspect or the third aspect.

According to a twentieth aspect, a computer program is provided, where the computer program causes a computer to execute the method according to the second aspect or the fourth aspect.

### BRIEF DESCRIPTION OF DRAWINGS

FIG. 1 is an example diagram of a wireless communications system to which an embodiment of this application is applicable.

FIG. 2 is a schematic diagram of a satellite network architecture based on transparent payload.

FIG. 3 is a schematic diagram of a satellite network architecture based on regenerative payload.

FIG. 4 is a schematic flowchart of a communication method according to an embodiment of this application.

FIG. 5 is a schematic flowchart of a communication method according to an embodiment of this application.

FIG. 6 is a schematic diagram of restarting, by a terminal device, a timer based on third information according to an embodiment of this application.

FIG. 7 is a schematic structural diagram of a communications apparatus according to an embodiment of this application.

FIG. 8 is a schematic structural diagram of a communications apparatus according to another embodiment of this application.

FIG. 9 is a schematic structural diagram of a communications apparatus according to still another embodiment of this application.

FIG. 10 is a schematic structural diagram of a communications apparatus according to still another embodiment of this application.

FIG. 11 is a schematic structural diagram of an apparatus according to an embodiment of this application.

### DESCRIPTION OF EMBODIMENTS

Technical solutions in this application are described below with reference to the accompanying drawings.

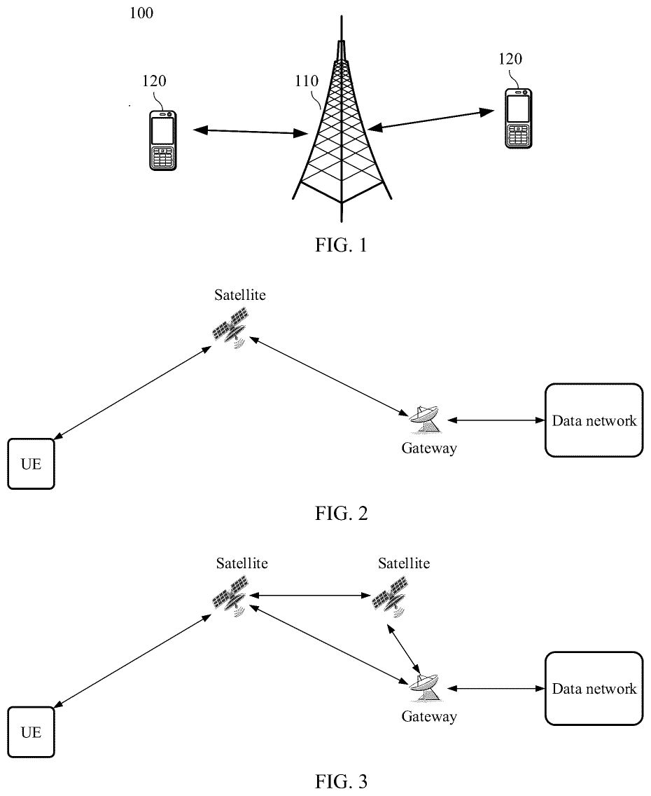

FIG. 1 shows a wireless communications system 100 to which an embodiment of this application is applied. The wireless communications system 100 may include a network device 110 and user equipments (UE) 120. The network device 110 may communicate with the UEs 120. The network device 110 may provide communication coverage for a specific geographic area, and may communicate with the UEs 120 within the coverage area. The UEs 120 may access a network (for example, a wireless network) by using the network device 110.

FIG. 1 exemplarily shows one network device and two UEs. Optionally, the wireless communications system 100 may include a plurality of network devices, and another quantity of terminal devices may be included within a coverage range of each network device, which is not limited in embodiments of this application. Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communications system, such as a 6th generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without the relay of a communication signal through a base station.

The network device in embodiments of this application may be a device configured to communicate with the UE. The network device may also be referred to as an access network device or a wireless access network device. For example, the network device may be a base station. The network device in embodiments of this application may be a radio access network (RAN) node (or device) that connects the UE to a wireless network. The base station may broadly cover various names in the following, or may be replaced with the following names: a NodeB, an evolved NodeB (cNB), a next generation NodeB (gNB), a relay station, an access point, a transmitting and receiving point (TRP), a transmitting point (TP), a primary MeNB, a secondary ScNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

In some embodiments, the network device may be stationary or mobile. For example, a helicopter or an unmanned aerial vehicle may be configured to function as a mobile network device, and one or more cells may move depending on a location of the mobile network device. In other examples, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or vehicle-mounted, may be deployed on a water surface, or may be deployed on a plane, a balloon, or a satellite in the air. In embodiments of this application, the network device and a scenario in which the network device is located in embodiments of this application are not limited.

It should also be understood that all or some of functions of the network device and the UE in this application may also be implemented by software functions running on hardware, or by virtualization functions instantiated on a platform (for example, a cloud platform).

The technical solutions in embodiments of this application may be applied to a non-terrestrial network (NTN) system. The NTN provides a terrestrial user with communication services in a non-terrestrial manner, and a satellite communications system is a common NTN system. In a satellite communications system, a network device (for example, a base station) may be a satellite. The satellite may remain stationary relative to a surface of the earth, or the satellite may move relative to a surface of the earth. For example, a network device in a satellite communications system may be a geostationary earth orbit (GEO) satellite or a non-geostationary earth orbit (NGEO) satellite. In addition, depending on orbital altitudes of satellites providing services, the NGEO satellite may be a highly-eccentric-orbit (HEO) satellite, a medium earth orbit (MEO) satellite, or a low earth orbit (LEO) satellite. The following describes the LEO satellite and the GEO satellite in detail.

An orbital altitude of the LEO satellite ranges from 500 km to 1500 km, with a corresponding orbital period of about 1.5 hours to 2 hours. A signal propagation delay of single-hop communication between users is generally less than 20 ms. A maximum satellite visible time is 20 minutes. A signal propagation distance is short, a link loss is small, and a transmit power requirement for a user terminal is not high.

An orbital altitude of the GEO satellite is 35786 km, with a period of rotation around the earth of 24 hours. A signal propagation delay of single-hop communication between users is generally 250 ms. To ensure coverage of a satellite and improve system capacity of an entire satellite communications system, the satellite may cover the ground by using a plurality of beams. For example, one satellite may form dozens or even hundreds of beams to cover the ground. One satellite beam may cover a terrestrial area of tens to hundreds of kilometers in diameter.

An NTN system may implement a network architecture based on a satellite. The satellite network architecture may include following network elements: a gateway, a feeder link, a service link, a satellite, an inter-satellite link, and the like. There may be one or more gateways. The gateway may be configured to connect a satellite to a terrestrial public network. The gateway is generally located on the ground. The feeder link may be a link for communication between the gateway and the satellite. The service link may be a link for communication between a terminal device and the satellite. The inter-satellite link may exist in a regenerative payload network.

Depending on different functions that satellites provide in networks, networks may be classified into a transparent payload network and a regenerative payload network. Details are as follows.

FIG. 2 is a schematic diagram of a satellite network architecture based on transparent payload. A satellite in this network may provide functions such as radio frequency filtering, frequency conversion, and amplification. However, the satellite in this network provides only transparent forwarding of signals, and does not change waveform signals forwarded by the satellite.

FIG. 3 is a schematic diagram of a satellite network architecture based on regenerative payload. Satellites in this network may provide functions such as radio frequency filtering, frequency conversion, and amplification. The satellites in this network may further provide at least one of following functions: demodulation or decoding, routing or conversion, and coding or modulation. It may be understood that the satellites in this network may have some or all of functions of a base station.

In the satellite network architectures shown in FIG. 2 and FIG. 3, a gateway may be configured to connect the satellites to a terrestrial public network, a link for communication between the gateway and the satellites may be referred to as a feeder link, a link for communication between a terminal device and the satellites may be referred to as a service link, and a link for communication between the satellites may be referred to as an inter-satellite link (shown in FIG. 3). It should be noted that only one gateway is shown in each of FIG. 2 and FIG. 3. Practically, one or more gateways may be deployed depending on specific cases.

In an NR terrestrial network, uplink transmissions from different UEs need to satisfy orthogonal multiple access in time and frequency, that is, uplink transmissions from different UEs in a same cell do not interfere with each other. To ensure orthogonality of uplink transmissions and avoid intra-cell interference, a gNB requires that signals, at a same moment but on different frequency domain resources, from different UEs arrive at the gNB with their time synchronized.

To ensure time synchronization on the gNB side, NR supports an uplink timing advance mechanism.

In the NR terrestrial network, an uplink clock on the gNB side is the same as a downlink clock on the gNB side. However, there is an offset between an uplink clock and a downlink clock on the UE side, and different UEs have different uplink timing advance values. Through proper control of an offset for each of different UEs, the gNB may control time at which uplink signals from the different UEs arrive at the gNB. Since a UE that is further away from the gNB has a larger transmission delay, the UE needs to transmit uplink data earlier than a UE closer to the gNB.

The gNB determines a timing advance (TA) value for each UE by measuring uplink transmission from the UE. The gNB may transmit a TA command to the UE in two manners.

Details are as follows.

### Manner 1: Obtaining Initial TA.

In a random access procedure, the gNB determines a TA value by measuring a received preamble, and transmits the TA value to the UE by using a timing advance command field of a random access response (RAR) message.

### Manner 2: Adjusting TA in a Radio Resource Control (RRC) Connected State.

In a random access procedure, although the UE implements uplink synchronization with the gNB, timing of an uplink signal from the UE arriving at the gNB may change with time. Therefore, the UE needs to continuously update its uplink timing advance value, so as to maintain uplink synchronization. If TA for a UE needs to be corrected, the gNB transmits a TA command to the UE, requiring the UE to adjust uplink timing. The timing advance command is transmitted to the UE by using a medium access control control element (MAC CE).

It may be learned from the foregoing description that, in a conventional TN network, the UE may maintain its TA based on the TA command delivered by the network. As in the TN system, in the NTN system, impact of TA also needs to be considered for the UE when the UE performs uplink transmission. In the NTN system, the UE generally has a GNSS positioning capability and a TA pre-compensation capability. The UE may estimate, based on a location of the UE and a location of a serving satellite, TA corresponding to a service link. Based on conclusions from current standardization meetings, for a UE in an idle state (RRC_IDLE)/inactive state (INACTIVE) and a connected state (RRC_CONNECTED), timing advance (that is, T_{TA}) thereof may be calculated according to the following formula: T_{TA}

$${T}_{TA} = ( {N}_{TA} + {N}_{TA , UE - specific} + {N}_{TA , common} + {N}_{TA , offset} ) \times {T}_{c}$$

N_{TA} represents a TA adjustment amount controlled by the network device; N_{TA,UE-specific} represents TA corresponding to a service link; N_{TA,common} represents common TA broadcasted by the network device, for example, may be TA corresponding to a feeder link, or may be another value; and N_{TA}, offset is a preset offset.

In the foregoing formula, the terminal device may adjust N_{TA} based on a TA command in a message 2 (Msg2), a message B (MsgB), or a MAC CE in the connected state. In a random access procedure, when the TA command is transmitted by using the message 1 (Msg1), a value for the TA command may be 0. The terminal device may learn location information of a satellite based on satellite ephemeris information broadcasted in a serving cell, and calculate a propagation delay (for example, N_{TA,UE-specific}) of a service link between the terminal device and the satellite based on GNSS location information of the terminal device and the location information of the satellite.

In NTN systems of some versions (for example, in a narrowband internet of things (IoT) NTN system of Release 17 (R17), that is, in a scenario of accessing an NTN using narrowband (NB)-IoT and enhanced machine type communication (cMTC)), a GNSS module and a communications module of the terminal device cannot operate simultaneously (Simultaneous GNSS and NTN NB-IoT/cMTC operation is not assumed). The terminal device can perform GNSS measurement based on the GNSS module and obtain GNSS location information (GNSS position fix) of the terminal device only when the terminal device is in the RRC idle state or the RRC inactive state, and the terminal device cannot enable the GNSS module when the terminal device is in the RRC connected state. Therefore, before entering the RRC connected state, the terminal device may perform measurement by using the GNSS module and obtain a GNSS location of the terminal device, determine validity duration of the GNSS location based on a status of the terminal device (for example, a moving state of the terminal device), and report remaining validity time of the GNSS location to the network during RRC connection establishment/RRC re-establishment/RRC connection restoration. Since the terminal device in the RRC connected state cannot perform GNSS measurement in the RRC connected state and cannot calculate TA, when a GNSS location of the terminal device expires, the terminal device needs to return to the RRC idle state or the RRC inactive state.

With continuous development of communications technologies, in some communications systems, the terminal device in the connected state may perform GNSS measurement by using the GNSS module and obtain GNSS location information (GNSS position fix) of the terminal device. However, a GNSS module and a communications module of a terminal device cannot operate simultaneously. When performing GNSS measurement, the terminal device needs to disable the communications module, which may affect scheduling of a network device.

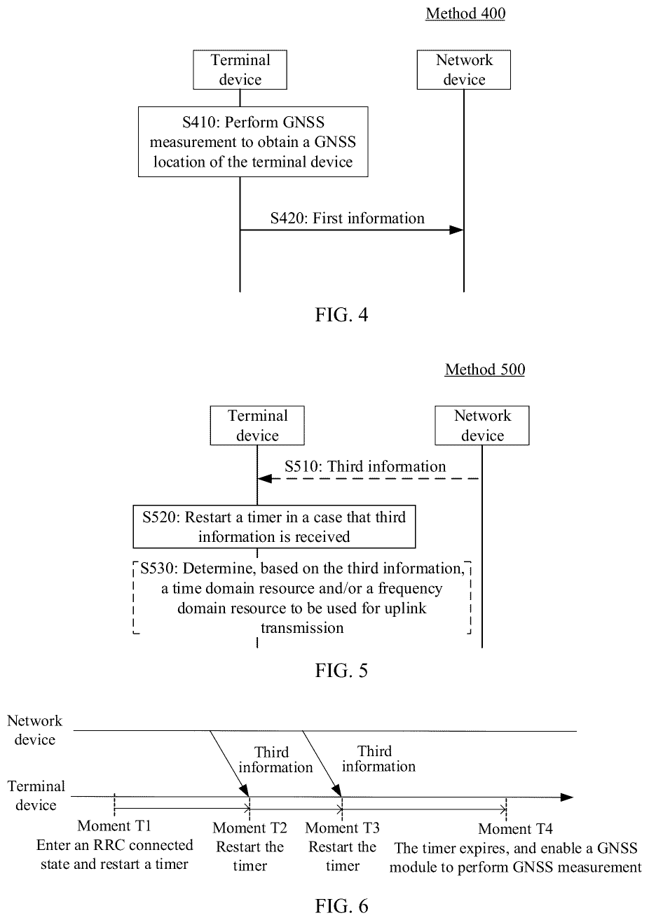

To resolve one or more of the foregoing technical problems, this application provides a communication method and a communications apparatus. With reference to FIG. 4 to FIG. 6, the following describes embodiments of this application in detail by using examples.

FIG. 4 is a schematic flowchart of a communication method according to an embodiment of this application. The method 400 shown in FIG. 4 may include steps S410 and S420. Details are as follows.

S410: A terminal device performs GNSS measurement to obtain a GNSS location of the terminal device.

Optionally, the terminal device may be a terminal device in an NTN system. For example, the terminal device may be a terminal device in a satellite communications system.

Optionally, the terminal device may be in a connected state. For example, the terminal device is in an RRC_CONNECTED state.

The terminal device may include a communications module and a GNSS module.

The GNSS module may be configured for the terminal device to perform GNSS measurement. For example, the terminal device may perform GNSS measurement by using the GNSS module and obtain GNSS location information (GNSS position fix) of the terminal device. Certainly, the terminal device may also use the GNSS module to perform other operations related to GNSS. The GNSS location may be a location of the terminal device.

The communications module may be configured for the terminal device to perform communication. For example, the terminal device may communicate with a network device by using the communications module.

After the GNSS location is invalid (or the GNSS location expires), the terminal device may disable the communications module, enable the GNSS module, and perform GNSS measurement by using the GNSS module and obtain a GNSS location.

For example, the terminal device may start a GNSS measurement timer in a timer-based manner, and perform GNSS measurement during running of the GNSS measurement timer and obtain a GNSS location.

For another example, the terminal device may introduce a gap in a gap-based manner, and perform GNSS measurement during the gap and obtain a GNSS location.

After completing GNSS measurement (that is, S410), the terminal device may disable the GNSS module, enable the communications module, and perform following S420.

S420: The terminal device transmits first information to the network device.

The network device may be a network device in an NTN system. For example, the network device may be a network device in a satellite communications system.

Optionally, the first information may be used to indicate that the GNSS location is valid.

The terminal device may transmit the first information to the network device in a plurality of manners. Details are as follows.

### Manner 1:

The terminal device may transmit the first information to the network device by using a radio resource control (RRC) message. Optionally, the RRC message may be a UEAssistanceInformation message.

The RRC message may be transmitted by using an uplink resource, for example, a configured grant (CG) resource. The CG resource may further carry a current TA value for the terminal device.

### Manner 2:

The terminal device may transmit the first information to the network device by using a medium access control control element (MAC CE). Optionally, the MAC CE may be a newly defined MAC CE that is used to indicate that the GNSS location of the terminal device is valid. For example, the MAC CE may be a newly defined GNSS valid MAC CE (for example, GNSS VALID MAC CE).

The MAC CE may be transmitted by using an uplink resource, for example, a configured grant (CG) resource. The CG resource may further carry a current TA value for the terminal device.

### Manner 3:

The terminal device may transmit the first information to the network device by using a physical uplink control channel (PUCCH). For example, the first information may be carried in uplink control information (UCI) in the PUCCH.

When transmitting the PUCCH, the terminal device needs to use valid TA, that is, the terminal device requires that a time alignment timer (TAT) is still running, and that obtained parameters such as ephemeris information from a serving cell and a common TA (that is, N_{TA,common} broadcasted by the network device) are still valid.

### Manner 4:

The terminal device may indicate the first information to the network device through a random access procedure. For example, in a case that the terminal device is to indicate the first information to the network device, the terminal device may initiate a random access to the network device. Since the terminal device can initiate a random access only when a GNSS location thereof is valid, the network device may accordingly learn that the GNSS location of the terminal device is valid. It may be learned that this manner is equivalent to implicitly indicating the first information to the network device.

In a process of transmitting the random access, the terminal device needs to use a TA pre-compensation technology, that is, the terminal device requires that obtained parameters such as ephemeris information from a serving cell and a common TA (that is, N_{TA,common} broadcasted by the network device) are still valid.

Optionally, the terminal device may further transmit second information to the network device, where the second information may include validity time of the GNSS location.

Optionally, the terminal device may determine the validity time of the GNSS location based on a status of the terminal device (for example, a moving state of the terminal device). For example, when there is a large change in a location of the terminal device (that is, the location is not fixed), the terminal device may set (or determine) a small value for the validity time of the GNSS location. When there is a small change in a location of the terminal device (that is, the location is relatively fixed), the terminal device may set (or determine) a large value for the validity time of the GNSS location. Further, in a case that the location of the terminal device is not fixed, a value for the validity time of the GNSS location may also be specifically set (or determined) based on a moving speed of the terminal device or a moving range of the terminal device within a specific period of time.

Optionally, the second information may be carried in an RRC message. For example, when the first information is transmitted to the network device in Manner 1, the second information may be carried in the RRC message, that is, the first information and the second information may be transmitted by using the same RRC message.

In a case that the first information is transmitted to the network device in Manners 2, 3, or 4, an RRC message that carries the second information may be transmitted to the network device.

In embodiments of this application, after updating a GNSS location, the terminal device in the connected state transmits the first information to the network device, such that the network device learns in a timely manner that the GNSS location of the terminal device is valid, so that the network device resumes scheduling of the terminal device as soon as possible, thereby reducing impact of the GNSS location update on network scheduling.

FIG. 5 is a schematic flowchart of a communication method according to an embodiment of this application. The method 500 shown in FIG. 5 may include step S520. Details are as follows.

S520: The terminal device restarts a timer in a case that third information is received.

Optionally, the terminal device may be a terminal device in an NTN system. For example, the terminal device may be a terminal device in a satellite communications system. Optionally, the terminal device may be in a connected state. For example, the terminal device is in an RRC_CONNECTED state.

Optionally, the terminal device may include a communications module and a GNSS module.

The third information may be transmitted by a network device. The network device may be a network device in an NTN system. For example, the network device may be a network device in a satellite communications system. Optionally, the third information may be used for the terminal device to perform time domain resource compensation and/or frequency domain resource compensation.

The terminal device may maintain the timer, or in other words, the timer may be deployed on the terminal device. The timer may be used to determine remaining validity time of a GNSS location of the terminal device, or the timer may be used to indicate validity time of a GNSS location of the terminal device. For example, the terminal device in the RRC connected state maintains a GNSS location valid timer (GNSS valid timer), and the GNSS location valid timer may indicate remaining validity time of the GNSS location of the terminal device. Optionally, duration of the timer may be determined by the terminal device.

Optionally, the terminal device may determine the validity time of the GNSS location based on a status of the terminal device (for example, a moving state of the terminal device). For example, when there is a large change in a location of the terminal device (that is, the location is not fixed), the terminal device may set (or determine) a small value for the validity time of the GNSS location. When there is a small change in a location of the terminal device (that is, the location is relatively fixed), the terminal device may set (or determine) a large value for the validity time of the GNSS location. Specifically, in a case that the location of the terminal device is not fixed, a value for the validity time of the GNSS location may also be specifically set (or determined) based on a moving speed of the terminal device or a moving range of the terminal device within a specific period of time. Further, the terminal device may set a valid duration of the timer based on the validity time of the GNSS location.

Optionally, duration of the timer may be configured by the network device. Optionally, the network device may alternatively determine the validity time of the GNSS location based on a moving state of the terminal device. Further, the network device may set the valid duration of the timer based on the validity time of the GNSS location.

Before S520, the method may further include step S510. Details are as follows.

S510: The network device transmits the third information to the terminal device.

For example, as shown in FIG. 6, the terminal device enters an RRC connected state at a moment T1. In this case, the terminal device may perform GNSS measurement and start the timer (for example, a GNSS location valid timer). When receiving the third information transmitted by the network device at a moment T2, the terminal device may restart the timer. The terminal device also receives, at a moment T3, third information transmitted by the network device, and may also restart the timer.

Optionally, the network device may transmit, based on a reception status of uplink transmission performed by the terminal device, the third information to the terminal device.

For example, in a case that a time domain offset of the uplink transmission is greater than or equal to a first threshold and/or a frequency domain offset of the uplink transmission is greater than or equal to a second threshold, the network device may transmit the third information to the terminal device.

Optionally, the third information may include a time domain compensation value and/or a frequency domain compensation value. Optionally, the network device may determine the time domain compensation value and/or the frequency domain compensation value based on a reception status of uplink transmission performed by the terminal device. For example, the network device may determine the time domain compensation value based on a time domain offset of uplink transmission performed by the terminal device, and/or the network device may determine the frequency domain compensation value based on a frequency domain offset of uplink transmission performed by the terminal device.

The method may further include step S530. Details are as follows.

S530: The terminal device determines, based on the third information, a time domain resource and/or a frequency domain resource to be used for uplink transmission.

For example, the terminal device may determine, by using a GNSS location (for example, a GNSS location last obtained by the terminal device) in combination with current valid ephemeris information and/or a common TA value broadcasted by the network device, and the time domain compensation value and/or the frequency domain compensation value indicated by the third information, the time domain resource and/or the frequency domain resource to be used for uplink transmission.

The terminal device may perform GNSS measurement in a case that the timer expires. For example, as shown in FIG. 6, at a moment T4 (after the terminal device restarts the timer), the timer expires. In this case (in a case that the timer expires), the terminal device may disable the communications module, enable the GNSS module, perform GNSS measurement by using the GNSS module, and obtain a GNSS location.

In embodiments of this application, the terminal device in the connected state restarts the timer in a case that the third information is received, which may reduce a quantity of times of GNSS measurement to be performed by the terminal device, so that impact of a GNSS location update on network scheduling can be reduced.

Further, the terminal device performs time domain resource compensation and/or frequency domain resource compensation for uplink transmission based on the time domain compensation value and/or the frequency domain compensation value indicated by the third information, such that the terminal device may continue to perform uplink transmission by using a previous GNSS location without updating the GNSS location, which may reduce a quantity of times of GNSS measurement to be performed by the terminal device, so that impact of a GNSS location update on network scheduling can be reduced.

It should be noted that the foregoing embodiments in FIG. 4 and FIG. 5 may be performed independently (that is, only the method in FIG. 4 is performed, or only the method in FIG. 5 is performed), or may be performed in combination (that is, both the method in FIG. 4 and the method in FIG. 5 are performed). This is not limited in embodiments of this application.

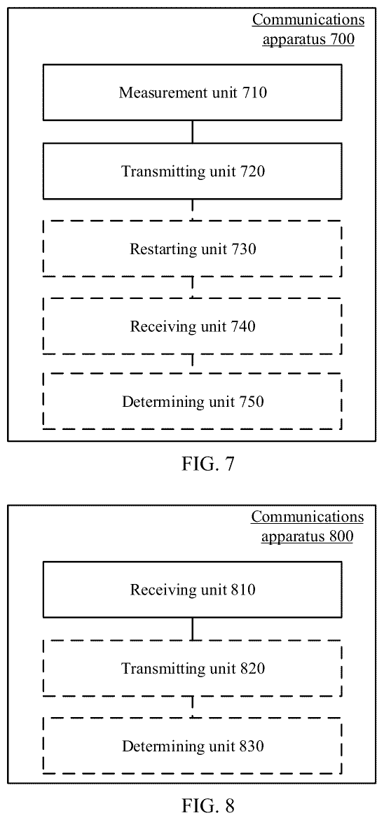

The method embodiments of this application are described in detail above with reference to FIG. 1 to FIG. 6. Apparatus embodiments of this application are described in detail below with reference to FIG. 7 and FIG. 11. It should be understood that the description of the method embodiments corresponds to the description of the apparatus embodiments, and therefore, for a part that is not described in detail, reference may be made to the foregoing method embodiments.

FIG. 7 is a schematic structural diagram of a communications apparatus according to an embodiment of this application. As shown in FIG. 7, the apparatus 700 includes a measurement unit 710 and a transmitting unit 720. Details are as follows.

The measurement unit 710 is configured to perform global navigation satellite system GNSS measurement to obtain a GNSS location of the apparatus, where the apparatus is in a connected state.

The transmitting unit 720 is configured to transmit first information to a network device, where the first information is used to indicate that the GNSS location is valid.

Optionally, the first information is carried in a radio resource control RRC message, a medium access control control element MAC CE, or a physical uplink control channel PUCCH, or the first information is indicated through a random access procedure.

Optionally, the RRC message or the MAC CE is transmitted using a configured grant CG resource.

Optionally, the transmitting unit 720 is further configured to transmit second information to the network device, where the second information includes validity time of the GNSS location.

Optionally, the second information is carried in a radio resource control RRC message.

Optionally, the apparatus 700 maintains a timer, and the timer is used to determine remaining validity time of the GNSS location. The apparatus 700 further includes: a restarting unit 730, configured to restart the timer in a case that third information transmitted by the network device is received, where the third information is used for the apparatus to perform time domain resource compensation and/or frequency domain resource compensation.

Optionally, duration of the timer is determined by the apparatus, or configured by the network device.

Optionally, the apparatus 700 further includes a receiving unit 740 and a determining unit 750. The receiving unit 740 is configured to receive the third information transmitted by the network device. The determining unit 750 is configured to determine, based on the third information, a time domain resource and/or a frequency domain resource to be used for uplink transmission.

Optionally, after the timer is restarted, the measurement unit 710 is further configured to perform GNSS measurement in a case that the timer expires.

Optionally, the network device is a network device in a non-terrestrial network NTN.

FIG. 8 is a schematic structural diagram of a communications apparatus according to an embodiment of this application. The communications apparatus 800 in FIG. 8 includes a receiving unit 810. Details are as follows.

The receiving unit 810 is configured to receive first information transmitted by a terminal device, where the first information is used to indicate that a global navigation satellite system GNSS location of the terminal device is valid, and the GNSS location is obtained by performing GNSS measurement when the terminal device is in a connected state.

Optionally, the first information is carried in a radio resource control RRC message, a medium access control control element MAC CE, or a physical uplink control channel PUCCH, or the first information is indicated through a random access procedure.

Optionally, the RRC message or the MAC CE is transmitted using a configured grant CG resource.

Optionally, the receiving unit 810 is further configured to receive second information transmitted by the terminal device, where the second information includes validity time of the GNSS location.

Optionally, the second information is carried in a radio resource control RRC message.

Optionally, the apparatus 800 further includes a transmitting unit 820, configured to transmit third information to the terminal device, where the third information is used for the terminal device to perform time domain resource compensation and/or frequency domain resource compensation.

Optionally, the transmitting unit 820 is specifically configured to transmit third information to the terminal device based on a reception status of uplink transmission performed by the terminal device.

Optionally, the transmitting unit 820 is specifically configured to: in a case that a time domain offset of the uplink transmission is greater than or equal to a first threshold and/or a frequency domain offset of the uplink transmission is greater than or equal to a second threshold, transmit the third information to the terminal device.

Optionally, the third information includes a time domain compensation value and/or a frequency domain compensation value. The apparatus 800 further includes a determining unit 830, configured to determine the time domain compensation value and/or the frequency domain compensation value based on a reception status of uplink transmission performed by the terminal device.

Optionally, the apparatus 800 is a network device in a non-terrestrial network NTN.

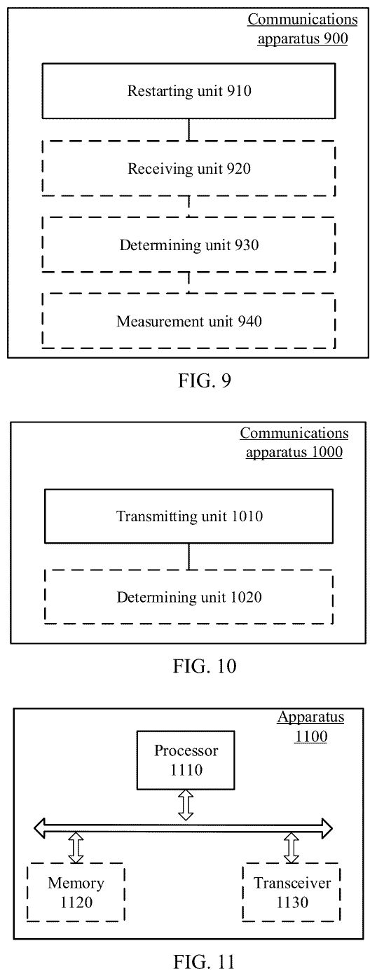

FIG. 9 is a schematic structural diagram of a communications apparatus according to an embodiment of this application. The communications apparatus 900 in FIG. 9 maintains a timer, and the timer is used to determine remaining validity time of a global navigation satellite system GNSS location of the apparatus. The apparatus 900 includes a restarting unit 910. Details are as follows.

The restarting unit 910 is configured to restart the timer in a case that third information transmitted by a network device is received, where the third information is used for the apparatus to perform time domain resource compensation and/or frequency domain resource compensation.

Optionally, duration of the timer is determined by the apparatus, or configured by the network device.

Optionally, the apparatus 900 further includes a receiving unit 920 and a determining unit 930. The receiving unit 920 is configured to receive the third information transmitted by the network device. The determining unit 930 is configured to determine, based on the third information, a time domain resource and/or a frequency domain resource to be used for uplink transmission.

Optionally, the apparatus 900 further includes a measurement unit 940. After the timer is restarted, the measurement unit 940 is configured to perform GNSS measurement in a case that the timer expires.

Optionally, the network device is a network device in a non-terrestrial network NTN.

FIG. 10 is a schematic structural diagram of a communications apparatus according to an embodiment of this application. The communications apparatus 1000 in FIG. 10 includes a transmitting unit 1010. Details are as follows.

The transmitting unit 1010 is configured to transmit third information to a terminal device, such that the terminal device restarts a timer in a case that the third information is received, where the timer is deployed on the terminal device, the timer is used to determine remaining validity time of a global navigation satellite system GNSS location of the terminal device, and the third information is used for the terminal device to perform time domain resource compensation and/or frequency domain resource compensation.

Optionally, the transmitting unit 1010 is specifically configured to transmit third information to the terminal device based on a reception status of uplink transmission performed by the terminal device.

Optionally, the transmitting unit 1010 is specifically configured to: in a case that a time domain offset of the uplink transmission is greater than or equal to a first threshold and/or a frequency domain offset of the uplink transmission is greater than or equal to a second threshold, transmit the third information to the terminal device.

Optionally, the third information includes a time domain compensation value and/or a frequency domain compensation value. The apparatus 1000 further includes a determining unit 1020, configured to determine the time domain compensation value and/or the frequency domain compensation value based on a reception status of uplink transmission performed by the terminal device.

Optionally, the apparatus 1000 is a network device in a non-terrestrial network NTN.

FIG. 11 is a schematic structural diagram of an apparatus according to an embodiment of this application. Dashed lines in FIG. 11 indicate that the unit or module is optional. The apparatus 1100 may be configured to implement the methods described in the foregoing method embodiments. The apparatus 1100 may be a chip or a communications apparatus.

The apparatus 1100 may include one or more processors 1110. The processor 1110 may allow the apparatus 1100 to implement the methods described in the foregoing method embodiments. The processor 1110 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program, where the program may be executed by the processor 1110, to cause the processor 1110 to perform the methods described in the foregoing method embodiments. The memory 1120 may be separate from the processor 1110 or may be integrated into the processor 1110.

The apparatus 1100 may further include a transceiver 1130. The processor 1110 may communicate with another device or chip by using the transceiver 1130. For example, the processor 1110 may transmit data to and receive data from another device or chip by using the transceiver 1130.

An embodiment of this application further provides a computer-readable storage medium, configured to store a program. The computer-readable storage medium may be applied to a communications apparatus provided in embodiments of this application, and the program causes a computer to perform a method to be performed by the communications apparatus in various embodiments of this application.

An embodiment of this application further provides a computer program product. The computer program product includes a program. The computer program product may be applied to a communications apparatus provided in embodiments of this application, and the program causes a computer to execute a method to be executed by the communications apparatus in various embodiments of this application.

An embodiment of this application further provides a computer program. The computer program may be applied to a communications apparatus provided in embodiments of this application, and the computer program causes a computer to execute a method to be executed by the communications apparatus in various embodiments of this application.

It should be understood that, in embodiments of this application, “B corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of the application, but the protection scope of the application is not limited thereto. Any variation or replacement readily figured out by a person skilled in the art within the technical scope disclosed in the application shall fall within the protection scope of the application. Therefore, the protection scope of this application shall be subject to the protection scope of the claims.

What is claimed is:

1. A communication method, comprising:
performing, by a terminal device, global navigation satellite system (GNSS) measurement to obtain a GNSS location of the terminal device, wherein the terminal device is in a connected state; and
transmitting, by the terminal device, first information to a network device, wherein the first information is used to indicate that the GNSS location is valid.

2. The method according to claim 1, wherein the first information is carried in a radio resource control (RRC) message, a medium access control control element (MAC CE), or a physical uplink control channel (PUCCH), or the first information is indicated through a random access procedure.

3. The method according to claim 1, wherein the method further comprises:
transmitting, by the terminal device, second information to the network device, wherein the second information comprises validity time of the GNSS location.

4. The method according to claim 3, wherein the second information is carried in a radio resource control (RRC) message.

5. The method according to claim 1, wherein the terminal device maintains a timer, and the timer is used to determine remaining validity time of the GNSS location; and
the method further comprises:
restarting, by the terminal device, the timer in a case that third information transmitted by the network device is received, wherein the third information is used for the terminal device to perform time domain resource compensation and/or frequency domain resource compensation.

6. The method according to claim 5, wherein duration of the timer is determined by the terminal device or configured by the network device.

7. The method according to claim 5, wherein the method further comprises:
receiving, by the terminal device, the third information transmitted by the network device; and
determining, by the terminal device based on the third information, a time domain resource and/or a frequency domain resource to be used for uplink transmission.

8. The method according to claim 1, wherein the network device is a network device in a non-terrestrial network (NTN).

9. A communications apparatus, comprising a memory, a transceiver, and a processor, wherein the memory is configured to store a program, the processor transmits data and receives data through the transceiver, and the processor is configured to invoke the program in the memory to cause the communications apparatus to execute the method comprising:
receiving, by a network device, first information transmitted by a terminal device, wherein the first information is used to indicate that a global navigation satellite system (GNSS) location of the terminal device is valid, and the GNSS location is obtained by performing GNSS measurement when the terminal device is in a connected state.

10. The apparatus according to claim 9, wherein the first information is carried in a radio resource control (RRC) message, a medium access control control element (MAC CE), or a physical uplink control channel (PUCCH), or the first information is indicated through a random access procedure.

11. The apparatus according to claim 9, wherein the method further comprises:
receiving, by the network device, second information transmitted by the terminal device, wherein the second information comprises validity time of the GNSS location.

12. The communications apparatus according to claim 11, wherein the second information is carried in a radio resource control (RRC) message.

13. The apparatus according to claim 9, wherein the method further comprises:
transmitting, by the network device, third information to the terminal device, wherein the third information is used for the terminal device to perform time domain resource compensation and/or frequency domain resource compensation.

14. The apparatus according to claim 13, wherein the transmitting, by the network device, third information to the terminal device comprises:
transmitting, by the network device based on a reception status of uplink transmission performed by the terminal device, the third information to the terminal device.

15. The apparatus according to claim 14, wherein the transmitting, by the network device based on a reception status of uplink transmission performed by the terminal device, the third information to the terminal device comprises:
in a case that a time domain offset of the uplink transmission is greater than or equal to a first threshold and/or a frequency domain offset of the uplink transmission is greater than or equal to a second threshold, transmitting, by the network device, the third information to the terminal device.

16. The apparatus according to claim 9, wherein the network device is a network device in a non-terrestrial network (NTN).

17. A communications apparatus, comprising a memory, a transceiver, and a processor, wherein the memory is configured to store a program, the processor transmits data and receives data through the transceiver, and the processor is configured to invoke the program in the memory to cause the communications apparatus to execute the method comprising:
performing global navigation satellite system (GNSS) measurement to obtain a GNSS location of the apparatus, wherein the apparatus is in a connected state; and
transmitting first information to a network device, wherein the first information is used to indicate that the GNSS location is valid.

18. The apparatus according to claim 17, wherein the first information is carried in a radio resource control (RRC) message, a medium access control control element (MAC CE), or a physical uplink control channel (PUCCH), or the first information is indicated through a random access procedure.

19. The apparatus according claim 17, wherein the method further comprises:
transmitting second information to the network device, wherein the second information comprises validity time of the GNSS location.

20. The apparatus according to claim 19, wherein the second information is carried in a radio resource control (RRC) message.
